(19) United States
(12) Patent Application Publication
(10) Pub. No.: US 2015/0154763 A1
(43) Pub. Date: Jun. 4, 2015

(54) CONTROL SYSTEM AND METHOD FOR CONTROLLING BACKGROUND COLORS FOR MOBILE TERMINAL

(71) Applicants: FU TAI HUA INDUSTRY (SHENZHEN) CO., LTD., Shenzhen (CN); HON HAI PRECISION INDUSTRY CO., LTD., New Taipei (TW)

(72) Inventors: ZHUO-LONG XIAN, Shenzhen (CN); CHIH-SAN CHIANG, New Taipei (TW); LING-JUAN JIANG, Shenzhen (CN); HUA-DONG CHENG, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 14/555,725

(22) Filed: Nov. 28, 2014

(30) Foreign Application Priority Data
Nov. 30, 2013 (CN) 201310622116.4

(51) Int. Cl. G06T 11/00; G06T 7/40

(52) U.S. Cl. CPC G06T 11/001; G06T 7/408

(57) ABSTRACT

A control system and method for controlling background color for a mobile terminal are provided. The control system includes a processor configured to execute instructions stored in a memory to: sample a plurality of pixels on a predetermined area during a predetermined interval; determine a main color among the sampled pixels, the main color is a color that most sampled pixels have; and determine a background color according to the main color.

### CROSS-REFERENCE TO RELATED APPLICATIONS

This application claims priority to Chinese Patent Application No. 201310622116.4 filed on Nov. 30, 2013, the contents of which are incorporated by reference herein.

### FIELD

The present disclosure relates to control systems, and particularly to a control system for controlling background colors of a mobile terminal.

### BACKGROUND

User interfaces of mobile terminals can include a plurality of items, where each item is displayed on an interface with a background color.

### BRIEF DESCRIPTION OF THE DRAWINGS

The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an embodiment of a control system for controlling background colors for a mobile terminal.

FIG. 2 is a diagrammatic view of a user interface shown on a mobile terminal running the control system of FIG. 1.

FIG. 3 is a diagrammatic view of a first block of the user interface shown in FIG. 2.

FIG. 4 is a diagrammatic view of a coordinate system created by a coordinate defining module shown in FIG. 1.

FIG. 5 is a diagrammatic view of a color loop stored in the storage module shown in FIG. 1.

FIG. 6 is a diagrammatic view of a filled block filled by the background color filling module shown in FIG. 1.

FIG. 7 is a flowchart of an embodiment of a method for controlling background colors for a mobile terminal.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The term “comprising” means “including, but not necessarily limited to”; it specifically indicates open-ended inclusion or membership in a so-described combination, group, series and the like.

The present disclosure is described in relation to a control system and method for controlling background color. The control system includes a processor configured to execute instructions stored in a memory to: sample a plurality of pixels on a predetermined area during a predetermined interval; determine a main color among the sampled pixels, and determine a background color according to the main color. In at least one embodiment, the main color is a color that most sampled pixels have.

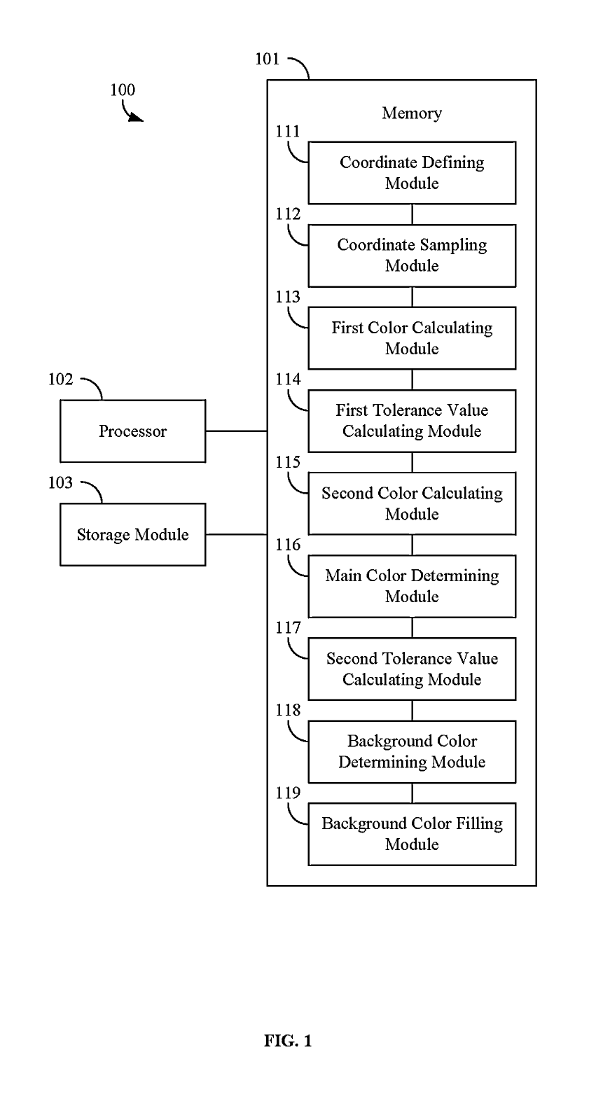

FIG. 1 illustrates an embodiment of a control system. The control system 100 can include a processor 102 and a storage module 103. The processor 102 executes instructions of a plurality of modules stored in a memory 101. The memory 101 can store a coordinate defining module 111, a coordinate sampling module 112, a first color calculating module 113, a first tolerance value calculating module 114, a second color calculating module 115, a main color determining module 116, a second tolerance value calculating module 117, a background color determining module 118 and a background color filling module 119.

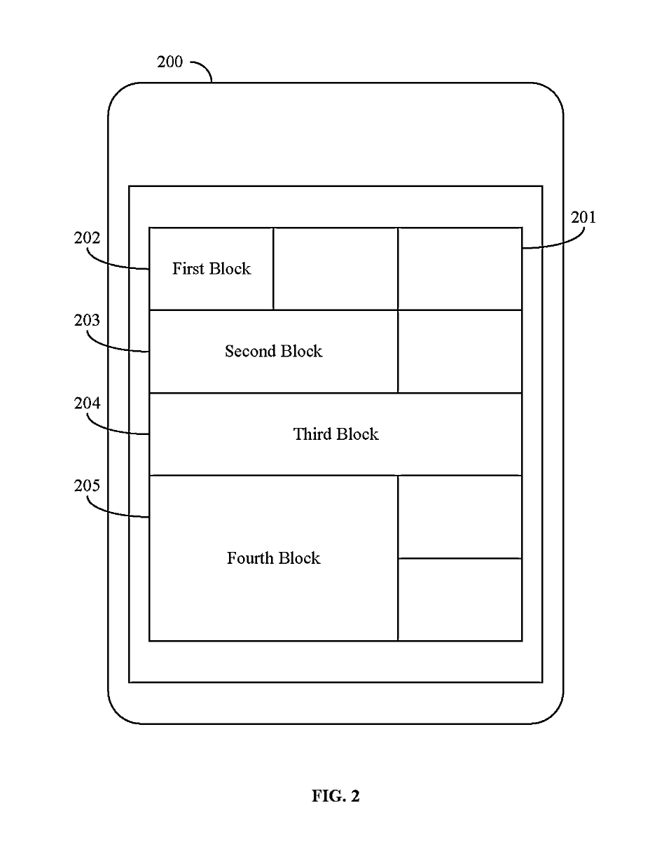

The control system 100 is applied to a mobile terminal 200 shown in FIG. 2. The mobile terminal 200 can be a mobile phone or a tablet computer, for example. The mobile terminal 200 provides a user interface 201, and the user interface 201 includes a plurality of blocks. In FIG. 2, an example of the user interface 201 is shown and the blocks can include a plurality of first blocks 202, a plurality of second blocks 203, a plurality of third blocks 204 and a plurality of fourth blocks 205. The first block 202, the second block 203, the third block 204 and the fourth block 205 have different sizes.

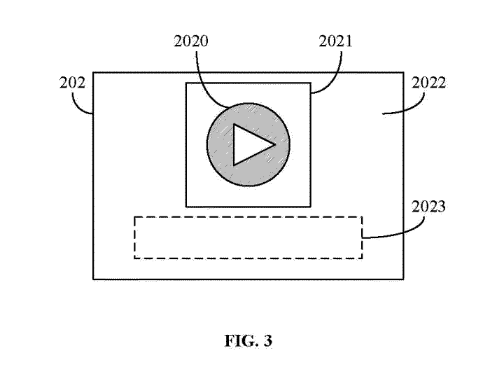

The first block 202, shown in FIG. 3, includes an item area 2021, a background area 2022 and an item name area 2023. The item area 2021 is configured for displaying an item 2020. In at least one embodiment, the item 2020 is an icon comprising a plurality of pixels.

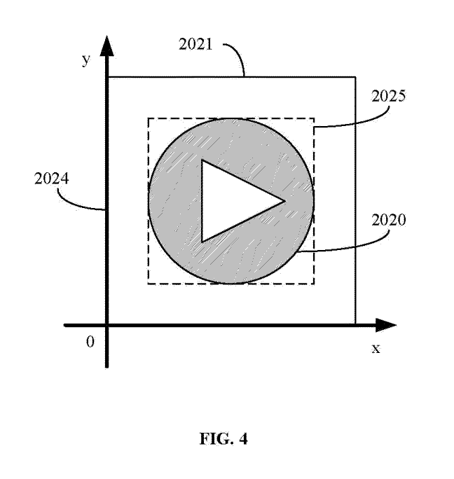

The coordinate defining module 111 creates a planar coordinate system 2024 shown in FIG. 4, when the item 2020 is displayed in the item area 2021. In at least one embodiment, an origin of the planar coordinate system 2024 is one of vertexes of the item area 2021. The X axis of the planar coordinate system 2024 is overlapped and extends along a first side of the item area 2021, and the Y axis of the planar coordinate system 2024 is overlapped and extends along a second side which is adjacent to the first side of the item area 2021.

The coordinate sampling module 112 samples the pixels of the item area 2021 on a predetermined sample area 2025. In at least one embodiment, the predetermined sample area 2025 is an area which has a smaller size than the size of the item area 2021. The coordinate sampling module 112 samples the pixels during a predetermined interval.

The first color calculating module 113 obtains red, green and blue (RGB) values of each pixel sampled by the coordinate sampling module 112.

The first tolerance value calculating module 114 calculates tolerance values of one of the sampled pixels with other sampled pixels. In at least one embodiment, the first tolerance value calculating module 114 randomly selects a sampled pixel P1(R1, G1, B1) of the sampled pixels, the values of R1, G1 and B1 are RGB values of P1. Then the first tolerance value calculating module 114 calculates tolerance value of P1 with other sampled pixels, for example P2(R2, G2, B2), the values of R2, G2 and B2 are RGB values of the sampled pixel P2. For example, if the RGB values of P1 are (33, 33, 43), and the RGB values of P2 are (31, 30, 48), the tolerance value t is t=max((33-31), (33-30))+max(|43-48|), then the tolerance value t is 8. After calculating the tolerance value of P1 with other sampled pixels, the first tolerance value calculating module 114 continue calculating the tolerance values of other randomly selected sampled pixels, except P1, with other sampled pixels.

The second color calculating module 115 calculates an amount of kinds of colors included in the sampled pixels, and an amount of sampled pixels included in each color, according to the tolerance values calculated by the first tolerance value calculating module 113. In at least one embodiment, the second color calculating module 115 determines whether the tolerance value t is smaller than a predetermined value, for example 10. If the tolerance value t is smaller than or equal to the predetermined value, the sampled pixel P1 is determined to have a same color as P2; otherwise, if the tolerance value t is larger than the predetermined value, the sampled pixel P1 is determined to have a different color as P2.

In one embodiment, if P1 is determined to have the same color as P2, the second color calculating module 115 continues to calculate the amount of sampled pixels which have a same color as P1. Then the second color calculating module 115 randomly selects a sampled pixel which is determined to have a different color as P1, for example P3, and counts the amount of pixels which have a same color as P3. According to this method, the second color calculating module 115 counts the amount of different colors included in the sampled pixels and the amount of sampled pixels included in each color.

In another embodiment, if the pixel P1 is determined to have a same color as P2, the second color calculating module 115 counts the amount of sampled pixels which have a same color as P1 as 2; otherwise, the amount of sampled pixels which have a same color as P1 and the amount of sampled pixels which have a same color as P2 are both counted as 1. Then the second color calculating module 115 randomly selects one sampled pixel, for example P3, and determines whether P3 has a same color as P1. If yes, the amount of sampled pixels which have a same color as P1 is added 1; if no, the amount of sampled pixels which have a same color as P3 is counted as 1, and the amount of sampled pixels which have a same color as P1 remains unchanged. According to this method, the second color calculating module 115 counts the amount of kinds of colors included in the sampled pixels, and the amount of sampled pixels included in each color.

The main color determining module 116 determines a main color according to the amount of kinds of colors included in the sampled pixels, and the amount of sampled pixels included in each color. In at least one embodiment, the main color determining module 116 determines a color that the most sampled pixels have, and then determines whether the determined color is a black color by comparing the RGB values of the determined color with (0, 0, 0), and determines whether the determined color is a white color by comparing the RGB values of the determined color with (255, 255, 255). If the determined color is determined as black or white, a gray color (128, 128, 128) is determined to be the main color; otherwise, if the determined color is determined not black nor white, the determined color is determined to be the main color.

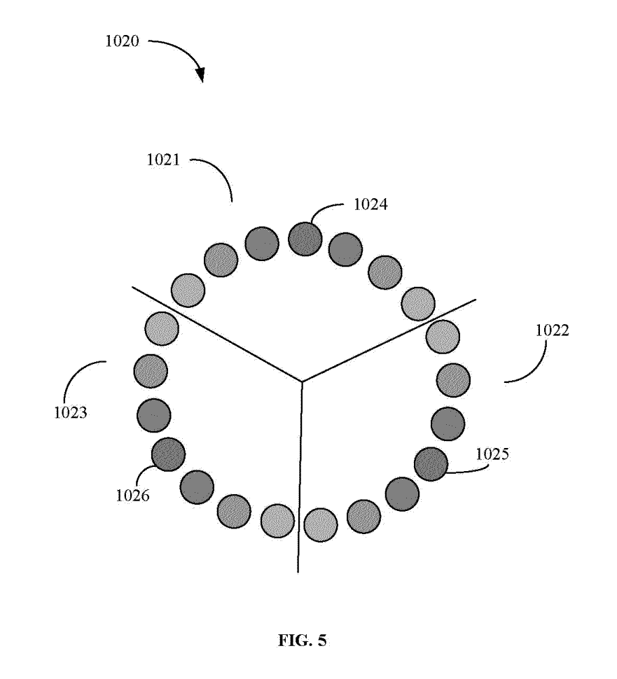

The storage module 103 stores a color loop 1020 shown in FIG. 5. The color loop 1020 can include a plurality of blocks each of which is filled with a different color, and the colors are different from each other. In at least one embodiment, the color loop 1020 can include a first color region 1021, a second color region 1022 and a third color region 1023. The first color region 1021 can include a first primary color 1024 and 6 gradually changing colors symmetrically arranged on two sides of the first primary color 1024. The second color region 1022 can include a second primary color 1025 and 6 gradually changing colors symmetrically arranged on two sides of the second primary color 1025. The third color region 1023 can include a third primary color 1026 and 6 gradually changing colors symmetrically arranged on two sides of the third primary color 1026. The storage module 103 also stores RGB values of each color in the color loop 1020.

The second tolerance value calculating module 117 calculates tolerance values of the main color with each color shown in the color loop 1020.

The background color determining module 118 determines a background color according to the tolerance values calculated by the second tolerance value calculating module 117. In at least one embodiment, the background color determining module 118 determines which color shown in the color loop 1020 have the smallest tolerance value with the main color. Then the background color determining module 118 determines two colors which are adjacent to the determined color, and randomly select one of the two colors as the background color.

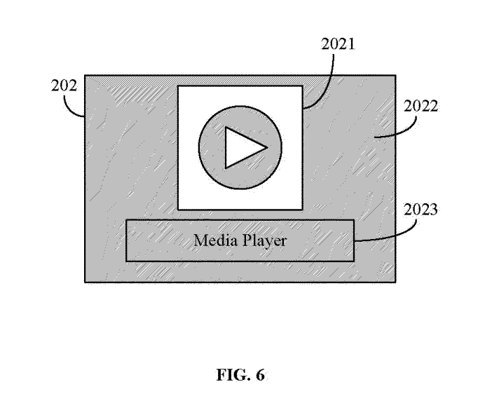

The background color filling module 119 fills the background area 2022 and the item name area 2023 with the background color, shown in FIG. 6. The background color filling module 119 also fills the item area 2023 with an item name of the item 2020.

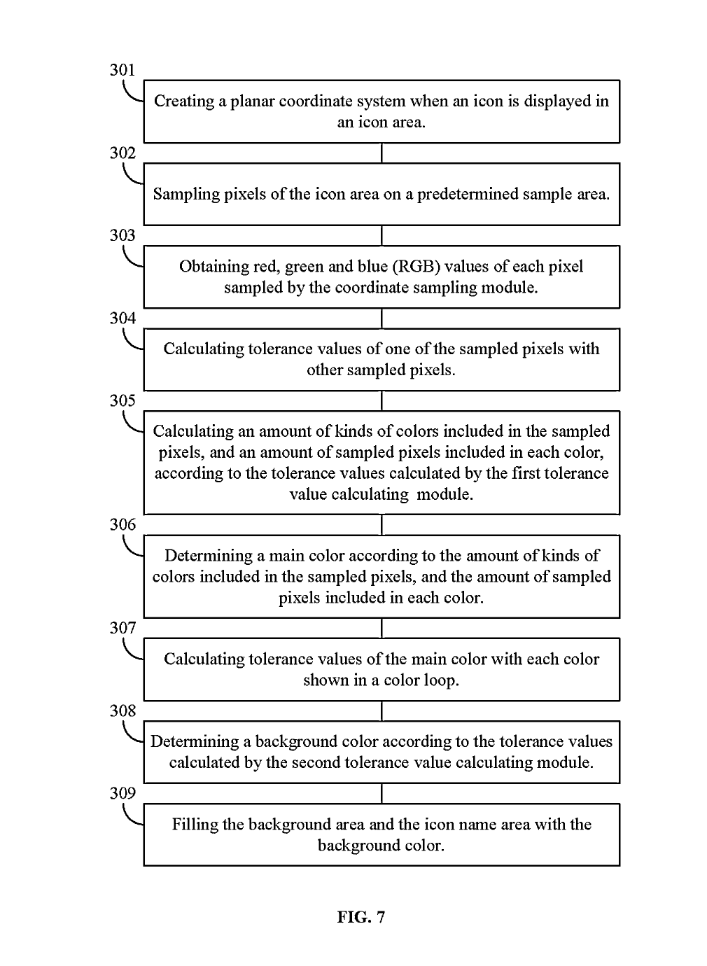

FIG. 7 illustrates a flowchart in accordance with an example embodiment. A method 300 is provided by way of example, as there are a variety of ways to carry out the method. The method 300 described below can be carried out using the configurations illustrated in FIG. 1 and various elements of these figures are referenced in explaining example method 300. Each block shown in FIG. 7 represents one or more processes, methods, or routines, carried out in the exemplary method 300. Additionally, the illustrated order of blocks is by example only and the order of the blocks can be changed. The exemplary method 300 can begin at block 301.

At block 301, a coordinate defining module creates a planar coordinate system when an item is displayed on an item area. In at least one embodiment, an origin of the planar coordinate system is one of vertexes of the item area. The X axis of the planar coordinate system is overlapped and extends along a first side of the item area, and the Y axis of the planar coordinate system is overlapped and extends along a second side which is adjacent to the first side of the item area.

At block 302, a coordinate sampling module samples pixels of the item area on a predetermined sample area. In at least one embodiment, the predetermined sample area is an area which has smaller size than the size of the item area. The coordinate sampling module samples the pixels during a predetermined interval.

At block 303, a first color calculating module obtains red, green and blue (RGB) values of each pixel sampled by the coordinate sampling module.

At block 304, a first tolerance value calculating module calculates tolerance values of one of the sampled pixels with other sampled pixels.

At block 305, a second color calculating module calculates an amount of kinds of colors included in the sampled pixels, and an amount of sampled pixels included in each color, according to the tolerance values calculated by the first tolerance value calculating module. In at least one embodiment, the second color calculating module determines whether the tolerance value t is smaller than a predetermined value, for example 10. If the tolerance value t is smaller than or equal to the predetermined value, the sampled pixel P1 is determined to have a same color as P2; otherwise, if the tolerance value t is larger than the predetermined value, the sampled pixel P1 is determined to have a different color as P2.

In one embodiment, if P1 is determined to have the same color as P2, the second color calculating module continues to calculate the amount of sampled pixels which have a same color as P1. Then the second color calculating module randomly selects a sampled pixel which is determined to have a different color as P1, for example P3, and counts the amount of pixels which have a same color as P3. According to this method, the second color calculating module counts the amount of kinds of colors included in the sampled pixels, and the amount of sampled pixels included in each color.

In another embodiment, if the pixel P1 is determined to have a same color as P2, the second color calculating module counts the amount of sampled pixels which have a same color as P1 as 2; otherwise, the amount of sampled pixels which have a same color as P1 and the amount of sampled pixels which have a same color as P2 are both counted as 1. Then the second color calculating module randomly selects one sampled pixel, for example P3, and determines whether P3 has a same color as P1. If yes, the amount of sampled pixels which have a same color as P1 is added 1; if no, the amount of sampled pixels which have a same color as P3 is counted as 1, and the amount of sampled pixels which have a same color as P1 remains unchanged. According to this method, the second color calculating module counts the amount of kinds of colors included in the sampled pixels, and the amount of sampled pixels included in each color.

At block 306, a main color determining module determines a main color according to the amount of kinds of colors included in the sampled pixels, and determines the amount of sampled pixels included in each color.

At block 307, a second tolerance value calculating module calculates tolerance values of the main color with each color shown in a color loop. The color loop can include a plurality of circles each of which is filled with a color, and the colors are different from each other. In at least one embodiment, the color loop can include a first color region, a second color region and a third color region. The first color region can include a first primary color and 6 gradually changing colors symmetrically arranged on two sides of the first primary color. The second color region can include a second primary color and 6 gradually changing colors symmetrically arranged on two sides of the second primary color. The third color region can include a third primary color and 6 gradually changing colors symmetrically arranged on two sides of the third primary color. The storage module also stores RGB values of each color in the color loop.

At block 308, a background color determining module determines a background color according to the tolerance values calculated by the second tolerance value calculating module. In at least one embodiment, the background color determining module determines which color shown in the color loop has the smallest tolerance value with the main color. Then the background color determining module determines two colors which are adjacent to the determined color, and randomly select one of the two colors as the background color.

At block 309, a background color filling module fills the background area and the item name area with the background color. The background color filling module also fills the item area with an item name of the item.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure, up to and including the full extent established by the broad general meaning of the terms used in the claims.

What is claimed is:

1. A control system for controlling background colors for a mobile terminal, the control system comprising:
a processor configured to execute instructions stored in a memory to:
sample a plurality of pixels on a predetermined area of an user interface of the mobile terminal during a predetermined interval;
analyze the sampled pixels and determine a main color among the sampled pixels, the main color is a color that the most sampled pixels have;
determine a background color according to the main color; and
fill a background area of the user interface with the background color.

2. The control system of claim 1, wherein the control system is further configured to execute instructions stored in the memory to create a planar coordinate system when an item is displayed on an item area.

3. The control system of claim 1, wherein the control system is further configured to execute instructions stored in the memory to:
calculate tolerance values of one of the sampled pixels with other sampled pixels; and
count an amount of kinds of colors comprised in the sampled pixels, and an amount of sampled pixels comprised in each color, according to the calculated tolerance values.

4. The control system of claim 1, wherein the control system is further configured to execute instructions stored in the memory to:
calculate tolerance values of the main color with each color of a color loop; and
determine the background color among the colors of the color loop.

5. The control system of claim 1, wherein the predetermined sample area is an area which has a smaller size than the size of the item area.

6. The control system of claim 2, wherein an origin of the planar coordinate system is one of vertexes of the item area, and the X axis of the planar coordinate system is overlapped and extends along a first side of the item area, the Y axis of the planar coordinate system is overlapped and extends along a second side which is adjacent to the first side of the item area.

7. The control system of claim 3, wherein the control system is further configured to execute instructions stored in the memory to:
determine two sampled pixels to have a same color if the tolerance value of the two pixels is smaller than or equal to a predetermined value; and
determine the two sampled pixels to have different colors if the tolerance value is bigger than the predetermined value.

8. The control system of claim 3, wherein the control system is configured to execute instructions stored in the memory to:
determine a color which has a smallest tolerance value among the calculated tolerance values;
determine a gray color as the main color if the determined color is determined to be black or white; and
determine the determined color as the main color if the determined color is determined not black nor white.

9. The control system of claim 4, wherein the color loop comprises a plurality of circles each of which is filled with a color, the color loop further comprises three color regions, each color region comprises a primary color and 6 gradually changing colors symmetrically arranged on two sides of the primary color.

10. The control system of claim 4, wherein the control system further configured to execute instructions stored in the memory to:
determine a color in the color loop which has the smallest tolerance value with the main color;
determine two colors which are adjacent to the determined color; and
select one of the two colors randomly as the background color.

11. A control method for controlling background color for a mobile terminal, the control method comprising:
executing instructions stored in a memory for:
sampling a plurality of pixels on a predetermined area of an user interface of the mobile terminal during a predetermined interval;
analyzing the sampled pixels and determining a main color among the sampled pixels, the main color is a color that the most sampled pixels have;
determining a background color according to the main color; and
filling a background area of the user interface with the background color.

12. The control method of claim 11, wherein sampling a plurality of pixels on a predetermined area during a predetermined interval comprises creating a planar coordinate system when an item is displayed on the item area.

13. The control method of claim 11, wherein determining a main color among the sampled pixels, which the main color is a color that most sampled pixels have comprises:
calculating tolerance values of one of the sampled pixels with other sampled pixels; and
counting an amount of kinds of colors comprised in the sampled pixels, and an amount of sampled pixels comprised in each color, according to the calculated tolerance values.

14. The control method of claim 11, wherein determining a background color according to the main color. comprises:
calculating tolerance values of the main color with each color of a color loop; and
determining the background color among the colors of the color loop.

15. The control method of claim 11, wherein sampling a plurality of pixels on a predetermined area during a predetermined interval comprises sampling the pixels of the item area in an area which has a smaller size than the size of the item area.

16. The control method of claim 12, wherein creating a planar coordinate system when an item is displayed on the item area comprises:
creating an origin of the planar coordinate system which is one of vertexes of the item area;
creating a X axis of the planar coordinate system which is overlapped and extends along a first side of the item area; and
creating a Y axis of the planar coordinate system which is overlapped and extends along a second side which is adjacent to the first side of the item area.

17. The control method of claim 13, wherein counting an amount of kinds of colors comprised in the sampled pixels, and an amount of sampled pixels comprised in each color, according to the calculated tolerance values comprises:
determining two sampled pixels to have a same color if the tolerance value of the two pixels is smaller than or equal to a predetermined value; and
determining the two sampled pixels to have different colors if the tolerance value is bigger than the predetermined value.

18. The control method of claim 13, wherein counting an amount of kinds of colors comprised in the sampled pixels, and an amount of sampled pixels comprised in each color, according to the calculated tolerance values comprises:
determining a color having a smallest tolerance value among the calculated tolerance values;
determining a gray color as the main color if the determined color is determined to be black or white; and
determining the determined color as the main color if the determined color is determined not black nor white.

19. The control method of claim 14, wherein determining the background color among the colors of the color loop comprise:
determining a color in the color loop which has the smallest tolerance value with the main color;
determining two colors which are adjacent to the determined color; and
selecting one of the two colors randomly as the background color.
